(19) United States
(12) Patent Application Publication
(10) Pub. No.: US 2008/0230006 A1
(43) Pub. Date: Sep. 25, 2008

(54) LENS COATING SYSTEM

(75) Inventors: David R. Kirchoff, Brooklyn Park, MN (US); Michael S. Erickson, Cedar, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: THE WALMAN OPTICAL COMPANY, Minneapolis, MN (US)

(21) Appl. No.: 11/688,080

(22) Filed: Mar. 19, 2007

(51) Int. Cl. B05C 11/00

(52) U.S. Cl. 118/695

(57) ABSTRACT

A shaft assembly of a lens coating system includes a first portion reversibly engagable with a second portion. A reciprocating drive disengages and subsequently re-engages the shaft first and second portions. A lens holder is coupled to an arm, which is coupled to the shaft first portion. Another drive, coupled to the shaft second portion, rotates the arm about an axis of the shaft assembly, when the first and second portions are engaged, such that the lens holder travels along a pathway surrounding the assembly. The system includes a plurality of stations, each station having an opening along the pathway, so that the rotating drive may transfer the lens holder into proximity with each station, when the shaft first and second portions are engaged, and the reciprocating drive may transfer a lens, held by the lens holder, into and out from each station through the opening thereof.

### TECHNICAL FIELD

The present invention pertains to systems for processing work pieces and more particularly to assemblies for a lens coating system.

### BACKGROUND

The optical, and particularly eyeglass, industry has made considerable progress in the use of coatings to improve the surface properties of desired substrate materials, such as polycarbonates. Common coatings include scratch resistant coatings and abrasion resistant coatings. Some coatings, which are sufficiently complex in chemistry and handling, must be applied in a factory or manufacturing setting, while other coatings can be applied by ophthalmology providers, on site in their own optical shop laboratories. For example, technicians in optical shop laboratories typically apply scratch resistant coatings that have compositions compatible with UV-curing. Automated and semi-automated systems for coating lenses are commercially available, e.g., as the Mini-II N/V Coating System and the M/R III System, both available from Ultra Optics, Brooklyn Park, Minn. But there is still a need in the industry, particularly in optical shop laboratories, for relatively simple and compact lens coating systems.

### SUMMARY

The present invention employs a combination of properties that can result in ease of use, flexibility, and a reduction in overall size, without compromising functionality. The nature of lens handling assemblies, according to embodiments of the present invention, can permit a lens coating system to be contained in a table-, or counter top-sized cabinet, as compared to a stand alone cabinet required for previous systems having similar functionality, such as the Applicant's own MR III system. In particular, two-part shaft assemblies employed by lens handling assemblies of the present invention can allow for a more compact arrangement of system components. Thus, a system according to embodiments of the present invention may be more suitable for retail optical shop laboratories than larger systems, such as the aforementioned MR III, which is typically employed in central optical laboratories. However, it should be noted that the scope of the present invention is not limited to relatively small, or compact coating systems, and embodiments of the present invention may be employed by any size lens coating system for use in any environment.

According to preferred embodiments of the present invention, a shaft assembly of a lens coating system includes a first portion reversibly engagable with a second portion. A reciprocating drive disengages and subsequently re-engages the first and second portions. A lens holder is coupled to an arm, which is coupled to the first portion of the shaft assembly. Another drive, coupled to the second portion, rotates the arm about an axis of the shaft assembly, when the first and second portions are engaged, such that the lens holder travels along a pathway surrounding the assembly. The system includes a plurality of stations, each station having an opening along the pathway, so that the rotating drive may transfer the lens holder into proximity with each station, when the first and second portions of the shaft assembly are engaged, and the reciprocating drive may transfer a lens held by the lens holder into and out from each station through the opening of each station.

Lens coating systems, according to some embodiments of the present invention, further include sensors employed to facilitate automatic operation of various processing stations, for example, washing, coating and curing stations, in conjunction with a lens handling assembly, which includes the shaft assembly and lens holder described above. These sensors may include a proximity sensor for indexing the lens holder to each station, another proximity sensor for homing the lens holder to a lens loading position from a lens unloading position, a positional sensor for monitoring the reciprocating drive, and, thus a location of the shaft second portion with respect to an opening of each station, and curtain sensors for monitoring loading and unloading of a lens into and out from the lens holder.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1A is a front elevation view of a lens coating system, according to some embodiments of the present invention.

FIG. 1B is a perspective view of an interior portion of the system shown in FIG. 1A, according to some embodiments.

FIG. 2 is an elevation view of a shaft assembly for the system shown in FIGS. 1A-B, according to some embodiments of the present invention.

FIG. 3 is a sectional schematic view of an exemplary washing station included in the system shown in FIGS. 1A-B, according to some embodiments of the present invention.

FIG. 4 is a sectional schematic view of an exemplary coating station included in the system shown in FIGS. 1A-B, according to some embodiments of the present invention.

FIG. 5 is a rear elevation view of the system shown in FIG. 1A, according to some embodiments of the present invention.

FIG. 6 is a simplified top plan view of the shaft assembly, according to some embodiments of the present invention.

FIGS. 7A-F are schematics describing an automated method of operation, according to some embodiments of the present invention.

### DETAILED DESCRIPTION

The following detailed description is exemplary in nature and is not intended to limit the scope, applicability, or configuration of the invention in any way. Rather, the following description provides practical illustrations for implementing exemplary embodiments of the present invention. Constructions, materials, dimensions, and manufacturing processes suitable for making embodiments of the present are known to those of skill in the field of the invention. Those skilled in the art will recognize that many of the examples provided have suitable alternatives that can be utilized.

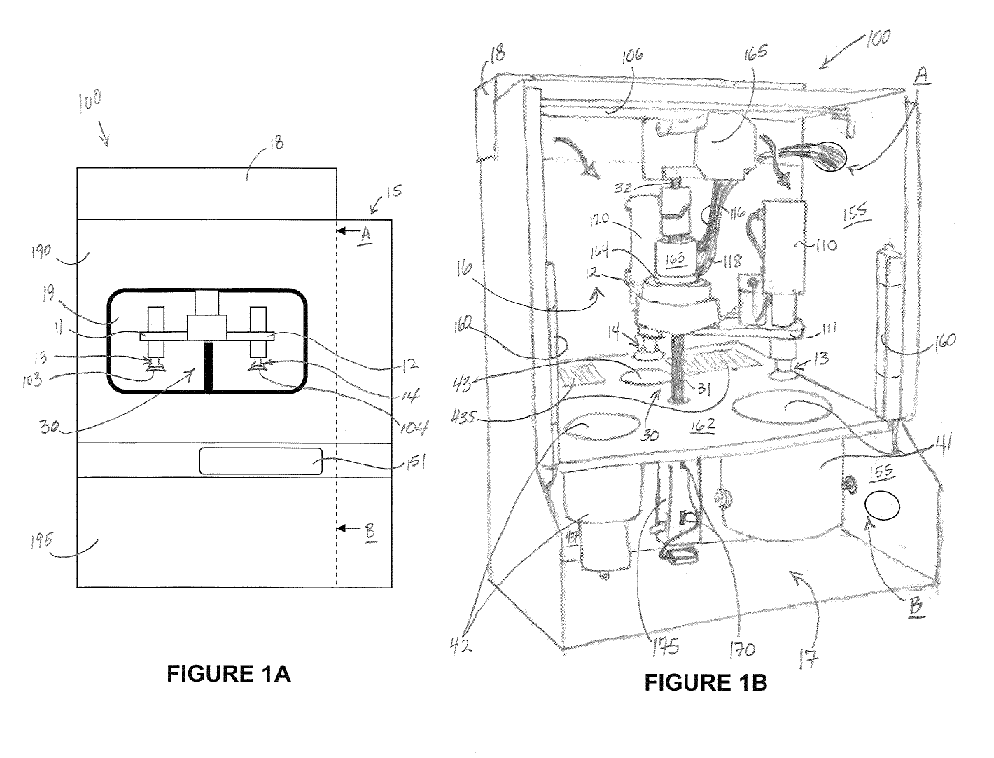

FIG. 1A is a front elevation view of a lens coating system 100, according to some embodiments of the present invention; and FIG. 1B is a perspective view of an interior portion of system 100, according to some embodiments. According to preferred embodiments of the present invention overall dimensions of system 100 are such that system 100 will fit on a table or counter top in an optical lab, for example, one housed within an optical retail facility; according to an exemplary embodiment, system 100 has a width between approximately 22 inches and approximately 30 inches, a depth between approximately 20 inches and approximately 28 inches, and a height between approximately 27 inches and approximately 35 inches. FIGS. 1A-B illustrate system 100 including a lens handling assembly contained in a first compartment 16, which is located above a second compartment 17; system 100 further includes a lens washing station 41, a lens coating station 42 and a lens curing station 43, each station 41, 42, 43 contained in compartment 17. FIGS. 1A-B further illustrate the lens handling assembly including a shaft assembly 30 to which a first arm 11 and a second arm 12 are coupled; each arm 11, 12 includes a lens holder 13, 14, respectively. FIG. 1A further illustrates an opening 19 in a front panel 190 of system 100 to allow access for loading and unloading of lenses 103, 104, which are shown held by lens holders 13, 14, respectively, and a fan assembly 18, which includes a HEPA filter, mounted above compartment 16 to provide air flow into compartment 16, per the arrows shown in FIG. 1B, in order to maintain a positive air pressure within compartment 16 and thereby prevent debris from entering compartment 16 at opening 19. With reference to FIG. 1B, a pair of sensors 160, for example, a Sunx light curtain, FS2BH series, mounted in compartment 16 can detect passage of a lens loading mechanism, for example, a hand/arm of an operator, through opening 19 to load and unload lenses 103, 104.

FIG. 1B further illustrates a base plate 162 separating first compartment 16 from second compartment 17 and including openings for each station 41, 42, 43, through which lens holders 13, 14 may pass lenses, for example, lenses 103, 104 (FIG. 1A), for processing within each station. A lower panel 195 of system 100, shown in FIG. 1A, may be hinged to provide access to second compartment 17, for example, for maintenance purposes. With further reference to FIG. 1B, it can be seen that shaft assembly 30 includes a shaft first portion 31, which extends through base plate 162, from second compartment 17, being coupled to a reciprocating drive 175, for example, a compressed air cylinder, that is contained in compartment 17, and a shaft second portion 32, which extends in first compartment 16, being coupled to a rotating drive 165, for example, an induction gear motor, such as a Brothers BF 25B12-200 SC 1C, that is mounted to a bracket 106 near a top of compartment 16. Shaft first and second portions 31, 32 are shown reversibly engaged with one another via a two-part coupling 350. According to the illustrated embodiment, when shaft first and second portions 31, 32 are engaged with one another, drive 165 rotates arms 11, 12, which are coupled to shaft first portion 31, so that lens holders 13, 14 travel along a pathway, surrounding shaft 30, on which the openings of each station 41, 42, 43 are located. When each lens holder 13, 14 is located over an opening of one of stations 41, 42, 43, reciprocating drive 175 may be activated to move shaft first portion 31 away from shaft second portion 32 thereby lowering lens holders 13, 14 into the corresponding station, for example, lens holder 14 into station 43 and lens holder 13 in station 41, for the position illustrated in FIG. 1B.

FIG. 1A further illustrates system 100 including an operator control panel 151 mounted above panel 195, to enable an operator of system 100 to select, for example, via a menu driven touch screen, a particular operating routine for system 100, for example, either one programmed to process a pair of lenses, or one programmed to process a single lens at a time. According to preferred embodiments, control panel 151 further provides selections for various operational parameters, feedback during automatic operation, diagnostics or troubleshooting routines, and a manual override of the automatic operation of system 100.

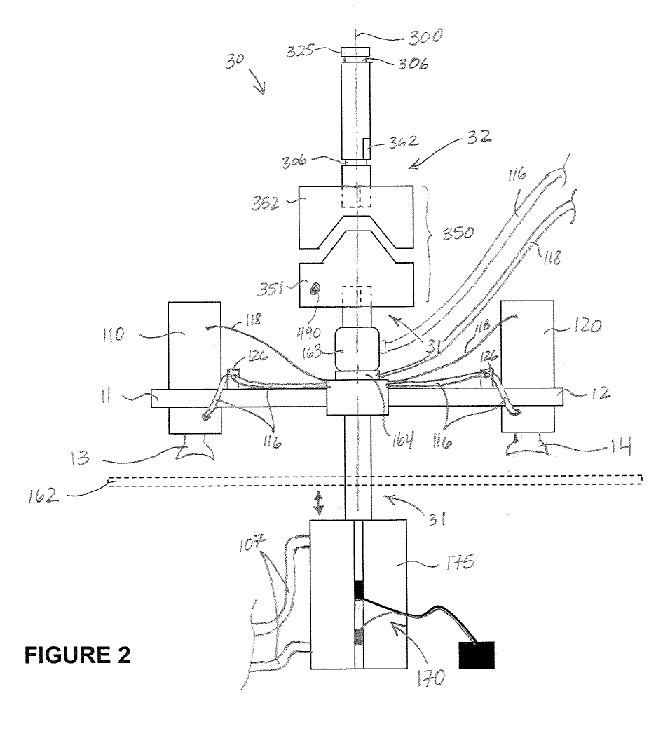

FIG. 2 is an elevation view of shaft assembly 30, according to some embodiments. FIG. 2 illustrates a first part 351 of two-part coupling 350 joined to shaft first portion 31, for example, being mounted on an end thereof and secured via set screws, above a rotary union 163, a slip ring 164, and arms 11, 12 of shaft first portion 31. FIG. 2 further illustrates a second part 352 of two-part coupling 350 joined to shaft second part 32, and shaft second part 32 including a keyway 362 and two grooves 306 for snap rings to accommodate coupling of rotational drive 165 thereto. According to the illustrated embodiment, reciprocating drive 175 moves shaft first portion 31 into and out of engagement with shaft second portion 32; when first and second portions 31, 32 are engaged, a female portion of second part 352 interlocks with a male portion of first part 351 to transfer rotation of shaft second part 32 to shaft first part 31 so that shaft assembly 30 rotates about an axis 300. It should be noted that other configurations of two-part coupling 350 may be employed to the same end. Drive 175, which may be any standard type of compressed air cylinder that includes a side weight support for arms 11, 12, is shown coupled to compressed air lines 107 and shown including a pair of sensors 170 for detecting a location of shaft first portion 31, for example, via a magnet riding with the air cylinder that drives shaft first portion 31. Sensors 170 provide feedback that indicates when shaft first portion 31 is located such that lens holders 13, 14 are holding lenses within any of stations 41, 42, 43, to activate processing within the station(s), and when shaft first portion 31 is engaged with shaft second portion 32 for rotation of lens holders 13, 14.

According to an exemplary embodiment of the present invention, each lens holder 13, 14 is part of a spindle assembly 110, 120 and each is like a suction cup, employing a suction force, augmented by a vacuum source (not shown) to hold a lens. Each spindle assembly 110, 120 is coupled to the vacuum source and may further include a pressure sensor (not shown), for example, a vacuum sensor available from Sunx, to detect the quality of vacuum between lens holder 13, 14 and lens, which is an indicator of when a lens is held by each holder 13, 14 and how well the lens is held. FIG. 2 illustrates a vacuum line 116 feeding into rotary union 163 of shaft first portion 31 and extending out along each arm 11, 12 to each spindle assembly 110, 120, through jars 126. According to the illustrated embodiments, each jar 126 provides a reservoir for any fluid which may inadvertently be drawn up into the corresponding spindle assembly 110, 120 at an interface between a lens and lens holder 13, 14, respectively, in order to prevent contamination of the vacuum system. An operator may control the vacuum for loading and unloading lenses into and out from holders 13, 14, for example, via a control, which may coupled to a foot pedal or may be coupled to a button or switch on control panel 151 (FIG. 1A).

According to the exemplary embodiment, each spindle assembly 110, 120 may further include a DC motor to spin a drive shaft, to which the corresponding lens holder 13, 14 is coupled. The spinning of a lens held by each of holders 13, 14 may facilitate processing of the lenses in washing station 41 and in coating station 42, which will be described below. FIG. 2 illustrates a bundle of wires 118, to power a DC motor for each spindle assembly 110, 120, feeding into a slip ring 164 of shaft first portion 31 and extending out along each arm 11, 12 to the corresponding spindle assembly 110, 120.

Referring back to FIG. 1A-B, it should be noted that system 100 includes another compartment 15, which is located alongside first and second compartments 16, 17, and in which electronic circuitry and various controls are mounted, for example to power and control the operation of shaft assembly 30 and spindle assemblies 110, 120, as well as various sensors and stations 41, 42, 43, the operation of which will be described below. According to the illustrated embodiment, compartment 15 is partitioned from compartments 16, 17 by a sidewall panel 155 (labeled in FIG. 1B and shown with dashed lines in FIGS. 1A and 5). FIGS. 1A-B illustrate various locations, generally designated A and B, at which feedthroughs may be located for the passage of wiring, air lines, shafts, etc. from compartment 15 into compartments 16 and 17, respectively. With reference to FIG. 5, which is a rear elevation view of system 100, another feedthrough C extends through a rear panel 157 of system 100 to provide a passageway for an air line extending from a filter assembly 145, which is mounted to rear panel 157, according to the illustrated embodiment; filter assembly 145 cleans compressed air fed into system, for example, for reciprocating drive 175 and/or drying in station 41.

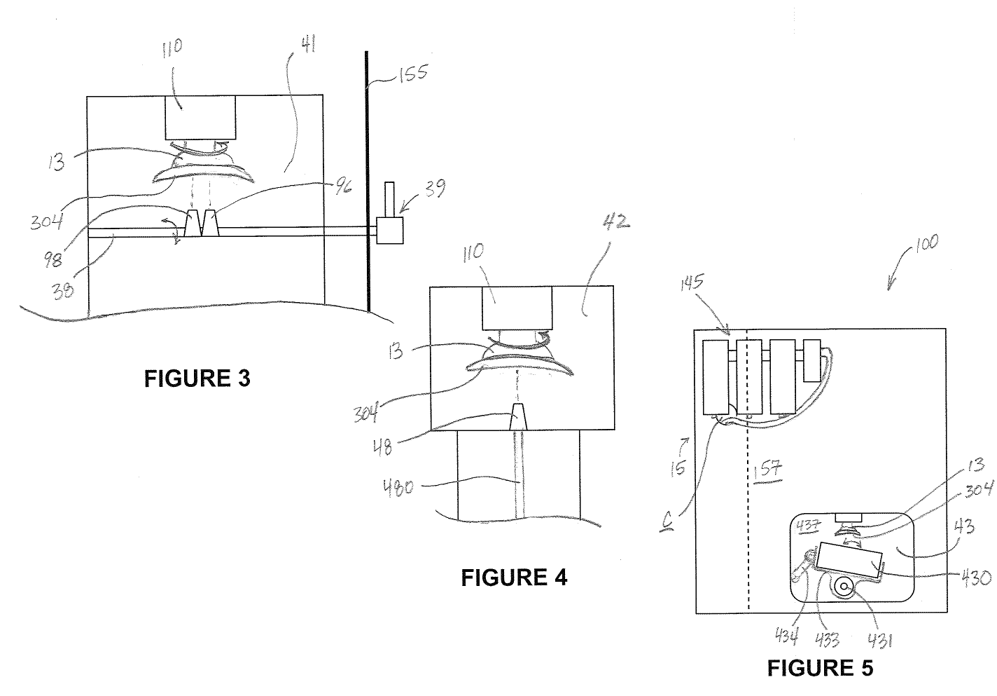

FIGS. 3-5 illustrate a general sequence, per clockwise rotation of the lens handling assembly shown in FIGS. 1A-B, of processing steps employed by system 100 for a lens 304 held in lens holder 13, starting with washing and drying at station 41 (FIG. 3) and ending with curing at station 43 (FIG. 5), after coating at station 42 (FIG. 4). Exemplary embodiments of washing station 41, coating station 42, and curing station 43 will be described in conjunction with FIGS. 3-5. It should be noted that the scope of the present invention is not limited to these exemplary embodiments and other types of stations, known to those skilled in the art, may be employed by alternate embodiments of the present invention.

FIG. 3 is a schematic section of an embodiment of washing station 41, patterned after that employed by the M/R III System available from Ultra Optics, Brooklyn Park, Minn. FIG. 3 illustrates a wash/dry tube 38 extending through station 41, just below lens 304, and including a spray nozzle 98 and an air nozzle 96 coupled thereto. According to the illustrated embodiment, a pump (not shown) supplies a washing fluid, for example de-ionized water, to spray nozzle 98, which directs a stream of the fluid toward lens 304, and an air inlet (not shown), which is coupled to a compressed air source, via filter assembly 145 (FIG. 5), feeds clean air to air nozzle 96. The pump and air tank are preferably located alongside station 41 within compartment 17 (FIG. 1B). During and/or following the washing process, lens 304 may be rotated; a rotational velocity of 1800 revolutions per minute may be suitable to help spin excess fluid off lenses in order to augment the drying process in which a stream of air is directed to lens 304 from nozzle 96. FIG. 3 further illustrates wash/dry tube 38 extending through a wall of station 41 and through panel 155 into compartment 15 (FIG. 1B) where tube 38 may be coupled to a gear motor, via a linkage 39, for pivoting of nozzles 98, 96 about an axis thereof.

FIG. 4 is a schematic section of an embodiment of coating station 41, patterned after that employed by the M/R III System available from Ultra Optics, Brooklyn Park, Minn. FIG. 4 illustrates a tube 480 for delivering coating material to nozzle 48, which is positioned below lens 304 being held by holder 13 in station 42; nozzle 48 is oriented to direct a stream or fountain of coating material onto lens 304. The coating material may be fed through a filter (not shown), downstream of tube 480, from a tank (not shown), both of which are preferably located alongside station 42 within compartment 17 (FIG. 1B). Spindle assembly 110 may rotate lens 304 while the stream, or fountain, of coating material impinges thereon, thereby facilitating a spreading of the coating material over a surface of lens 304. When the fountain is turned off, spindle assembly 110 may continue to rotate lens 304 in order to spin off excess coating. According to an exemplary embodiment, a first rotational velocity, during fountain operation, is approximately 400 revolutions per minute, and a second rotational velocity, when the fountain is turned off, is approximately 2000 revolutions per minute. According to an exemplary embodiment of the present invention, the coating applied in station 42 is curable via ultra-violet (UV) light in curing station 43; examples of appropriate coatings include UV-NV coatings available from Ultra Optics of Brooklyn Park, Minn.

Curing station 43 may be seen in the FIG. 5 rear elevation view of system 100. A UV lamp 430 may be seen through an opening in rear panel 157, exposed by removal or opening of a door (not shown). FIG. 5 illustrates lamp 430 held by a tray 433 mounted on a pivot shaft 431, which is coupled to a pivot arm 434 driven by a cam (not shown), which is, in turn, coupled to a gear motor (not shown), so that, during the curing of lens 304 (shown held by holder 13 in station 43), lamp 430 pivots back and forth per the arrow of FIG. 5. According to the illustrated embodiment, the cam and gear motor are located within station 43 along with lamp 430. Referring back to FIG. 1B in conjunction with FIG. 5, it should be appreciated that, according to the illustrated embodiment, station 43 is a sub-compartment of compartment 17 being separated, from stations 41 and 42, by a wall 437. With further reference to FIG. 1B, ventilation of station 43 is provided by vents 435 in base plate 162, according to the illustrated embodiment.

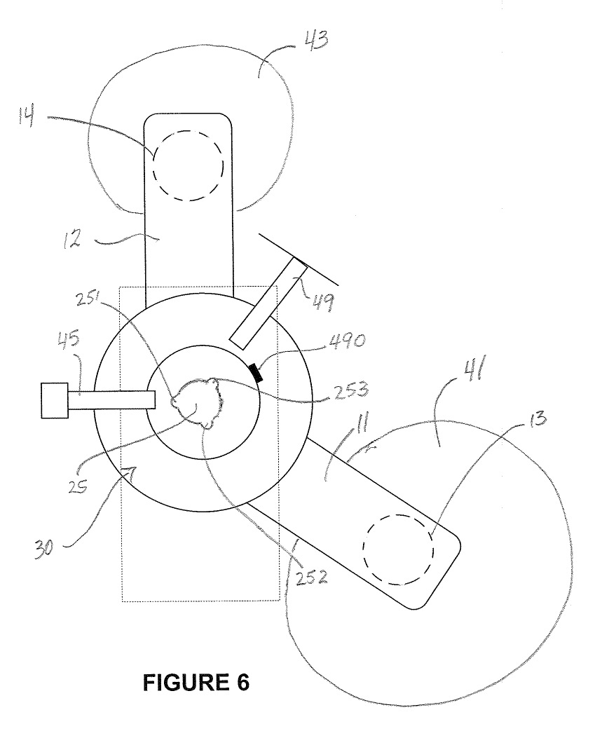

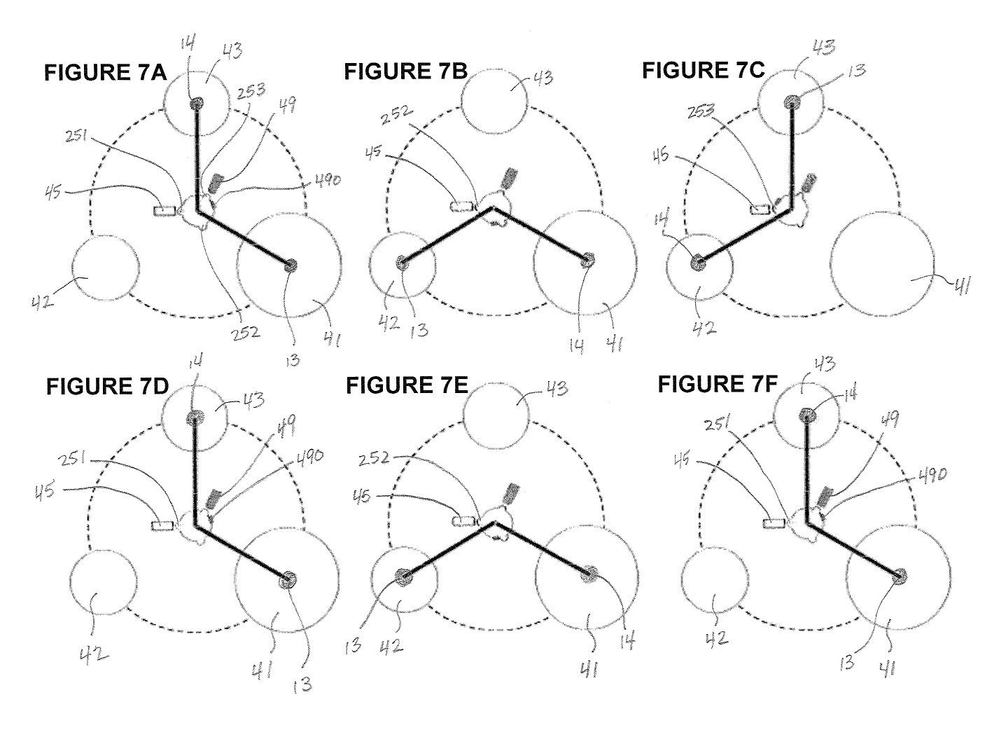

Indexing and homing of the lens handling assembly of system 100, which facilitates automatic operation of system 100 for processing a pair of lenses, will now be described in conjunction with FIGS. 6 and 7A-F. Although the operation described below encompasses the automatic processing of a pair of lenses through each station 41, 42, 43 of system 100, it should be understood that the scope of the present invention is not so limited, and that alternate methods for processing one lens, or two lenses, or even more lenses may be employed by alternate embodiments of the present invention.

FIG. 6 is a simplified top plan view of shaft assembly 30 within system 100, according to some embodiments of the present invention, wherein rotating drive 165 (FIG. 1B) is shown with dashed lines. FIG. 6 illustrates a first proximity switch 45, for example, mounted to bracket 106 (FIG. 1B), operating in conjunction with a lobed indexing indicator disk 25, which, with reference back to FIG. 2, is mounted to an end 325 of shaft second portion 32 above drive 165; disk 25 includes first, second and third lobes 251, 252, 253, respectively, which are positioned about shaft assembly 30 to correspond with three indexed locations of lens holders 13, 14 adjacent to the openings of two of the three stations 41, 42, 43. A first indexed location, or home, is illustrated in FIG. 6, wherein proximity switch 45 detects, or is tripped by, lobe 251 when lens holder 13 is adjacent the opening of station 41 and lens holder 14 is adjacent to opening of station 43. FIG. 6 further illustrates a second proximity switch 49, for example mounted to a plate suspended from bracket 106, operating in conjunction with a homing indicator 490, which, with reference back to FIG. 2, is mounted on second part 352 of two-part coupling 350. According to the illustrated embodiment, homing indicator 490 is positioned about shaft assembly, slightly offset from lobe 253, in order to trip second proximity switch 49, after lobe 253 of disk 25 trips first proximity switch 45, so that shaft assembly 30 continues to rotate to the home position where lobe 251 trips first proximity switch 45.

FIGS. 7A-F are schematics for reference in conjunction with a description of an automatic operation of system 100, according to some embodiments of the present invention. FIG. 7A, like FIG. 6, illustrates a start-up position, or home, for arms 11, 12, wherein first lens holder 13 is located in proximity to washing station 41, which is a lens loading position for first lens 103. Loading of lens 103 is detected as being completed when sensors 160 (previously described in conjunction with FIG. 1B) detect a loading mechanism, for example an operator's hand, passing through system opening 19 (FIG. 1A) twice, moving in and then back out; upon detection that the loading of first lens is complete, reciprocating drive 175 moves shaft first portion 31, with respect to shaft second portion 32, in order to transfer first lens 103, loaded in lens holder 13, into washing station 41, for washing and drying, and then back out of washing station 41. Once sensor 170 detects that shaft first portion 31 is re-engaged with shaft second portion 32, rotational drive 165 rotates shaft assembly 30, until proximity switch 45 is tripped by lobe 252, such that arms 11, 12 are located as shown in FIG. 7B, for loading of second lens 104 into lens holder 14 of second arm 12.

Once a completion of the loading of second lens 104 is detected, in similar manner as that described for first lens 103, drive 175 moves shaft first portion 31 in order to transfer first lens 103 into coating station 41, for coating, and second lens 104 into washing station 41, for washing and drying, and then to transfer each lens 103, 104 back out of the respective stations. After sensor 170 detects that shaft first portion 31 is re-engaged with shaft second portion 32, drive 165 rotates shaft assembly 30, so that proximity switch 45 is tripped by lobe 253 to locate arms 11, 12 at the next position shown in FIG. 7C.

Once lens holders 13, 14 are indexed into the position of FIG. 7C, reciprocating drive 175 moves shaft first portion 31 to transfer first lens 103 into cure station 43, for curing, and second lens 104 into coating station 42, for coating, and then moves shaft first portion 31 to transfer lenses 103, 104 back out of the respective stations. Drive 165, in response to the appropriate detection of sensors 170, then rotates shaft assembly 30, until proximity switch 45 is tripped by lobe 251, such that arms 11, 12 are located as shown in FIG. 7D.

Once lens holders 13, 14 are indexed into the position of FIG. 7D, the processing of first lens 103 has been completed. At the position of FIG. 7D, drive 175 moves shaft first portion 31 to transfer first lens 103 back into washing station 41, and second lens 104 into curing station 42, for curing, and moves shaft first portion 31 then to transfer lenses 103, 104 back out of the respective stations. Although first lens 103 is transferred into washing station 41, at the position of FIG. 7D, system 100 has registered that the processing of first lens 103 is complete, so system 100 knows that washing station 41 should not be activated. After the curing of lens 104, which completes the processing thereof, and when sensors 170 detect that shaft first portion 31 is re-engaged with shaft second portion 32, drive 165 rotates shaft assembly 30, until proximity switch 45 is tripped by lobe 252, such that arms 11, 12 are located as shown in FIG. 7E, where lenses 103, 104 are unloaded from system 100.

Unloading of lenses 103, 104 may be detected in a similar manner to the detection of loading, wherein sensors 160 detect passage of a lens loading mechanism back and forth through system opening 19 and vacuum sensors for lens holders 13, 14 detect a break in the vacuum for release of lenses 13, 14. Once completion of the unloading of lenses 103, 104 is detected, rotational drive 160 rotates shaft assembly 30 back around to the home position, illustrated in FIG. 7F, which is the same as that illustrated in FIG. 7A. As previously described in conjunction with FIG. 6, homing indicator 490 trips proximity switch 49 as an indication that when the next lobe, lobe 251, is detected by first proximity switch 45, arms 11, 12 are once again in the home position for loading of another first lens of a new pair of lenses to be processed.

In the foregoing detailed description, the invention has been described with reference to specific embodiments. However, it may be appreciated that various modifications and changes can be made without departing from the scope of the invention as set forth in the appended claims.

We claim:

1. A lens coating system, comprising:
a shaft assembly including a first portion and a second portion, the first portion reversibly engagable with the second portion;
at least one arm coupled to the first portion of the shaft assembly and extending outward therefrom;
a lens holder coupled to each arm of the at least one arm;
a rotating drive coupled to the second portion of the shaft assembly for rotating the at least one arm about an axis of the shaft assembly, when the first portion of the shaft assembly is engaged with the second portion of the shaft assembly, such that the lens holder travels along a pathway surrounding the shaft assembly;
a reciprocating drive coupled to the first portion of the shaft assembly, the reciprocating drive for moving the first portion of the shaft assembly away from the second portion of the shaft assembly, thereby disengaging the first portion from the second portion, and for subsequently moving the first portion back toward the second portion and into engagement with the second portion; and
a plurality of lens processing stations, each station including an opening, the openings located along the pathway;
wherein the rotating drive transfers each lens holder into proximity with each station, in turn, when the first portion of the shaft is engaged with the second portion of the shaft; and
the reciprocating drive transfers a lens held by each lens holder into and out from each station, in turn, through the opening of each station.

2. The system of claim 1, wherein the first portion of the shaft assembly is located below the second portion of the shaft assembly.

3. The system of claim 1, wherein the shaft assembly extends vertically.

4. The system of claim 1, wherein the pathway defines a circle approximately centered on the axis of the shaft assembly.

5. The system of claim 1, wherein:
the plurality of stations comprise a first station for washing, a second station for coating and a third station for curing;
a center of the opening of the washing station is located approximately 120 degrees away from a center of the opening of the curing station, about the axis of the shaft assembly;
a center of the opening of the coating station is located approximately 120 degrees away from the center of the opening of the washing station, about the axis of the shaft assembly; and
the center of the opening of the curing station is located approximately 120 degrees away from the center of the opening of the coating station, about the axis of the shaft assembly.

6. The system of claim 1, wherein:
the at least one arm comprises a first arm and a second arm; and
the lens holder of the first arm is spaced apart by approximately 120 degrees from the lens holder of the second arm, about the axis of the shaft assembly.

7. The system of claim 1, further comprising a proximity switch coupled to the second portion of the shaft assembly, the proximity switch providing indexing feedback for the rotating drive to locate the lens held by each lens holder adjacent to the opening of each station, in turn, and for the reciprocating drive to subsequently move the first portion of the shaft assembly away from the second portion of the shaft assembly to transfer the lens into each station, in turn.

8. The system of claim 1, further comprising a sensor to detect when the first portion of the shaft assembly has been moved away from the second portion of the shaft assembly to position the lens held by each lens holder within one of the plurality of stations.

9. The system of claim 1, wherein:
the plurality of stations comprise a first station for washing, a second station for coating and a third station for curing;
the at least one arm comprises a first arm and a second arm, the first and second arms being coupled in fixed relation to one another;
the lens holder of the first arm is spaced apart from the lens holder of the second arm, about the axis of the shaft assembly; and
a loading position for a first lens is where the rotating drive has transferred the lens holder of the first arm into proximity with the washing station, and the lens holder of the second arm into proximity with the cure station.

10. The system of claim 9, further comprising a sensor to detect when loading of the first lens into the lens holder of the first arm is complete, the detection activating the reciprocating drive to move the first portion of the shaft assembly away from the second portion of the shaft assembly and thereby position the first lens, held by the lens holder, within the washing station.

11. The system of claim 10, further comprising a system opening providing access for loading the first lens into the lens holder, and wherein the sensor comprises a pair of curtain sensors located on either side of the opening.

12. The system of claim 10, wherein the lens holder of each arm comprises a suction cup and the sensor comprises a vacuum sensor for each lens holder.

13. The system of claim 10, further comprising another sensor to detect when the first portion of the shaft assembly has been moved away from the second portion of the shaft assembly such that the first lens is positioned within the washing station, wherein the detection of the other sensor activates the washing station.

14. The system of claim 9, wherein a loading position for a second lens is where the rotating drive has transferred the lens holder of the first arm into proximity with the coating station, and the lens holder of the second arm into proximity with the washing station.

15. The system of claim 14, further comprising a sensor to detect when loading of the second lens into the lens holder of the second arm is complete, the detection activating the reciprocating drive to move the first portion of the shaft assembly away from the second portion of the shaft assembly and thereby position the first lens, held by the lens holder of the first arm, within the coating station and the second lens, held by the lens holder of the second arm, in the washing station.

16. The system of claim 15, further comprising a system opening providing access for loading the first and second lenses into the corresponding lens holders, and wherein the sensor comprises a pair of curtain sensors located on either side of the opening.

17. The system of claim 15, wherein the lens holder of each arm comprises a suction cup and the sensor comprises a vacuum sensor for each lens holder.

18. The system of claim 15, further comprising another sensor to detect when the first portion of the shaft assembly has been moved away from the second portion of the shaft assembly such that the first lens is positioned within the coating station and the second lens is positioned within the washing station, wherein the detection of the other sensor activates the coating and washing stations.

19. The system of claim 14, wherein an unloading position, for both of the first and second lenses, is where the rotating drive has transferred the lens holder of the first arm into proximity with the coating station, and the lens holder of the second arm into proximity with the washing station, after having transferring both lens holders into proximity with the curing station.

20. The system of claim 19, further comprising:
a first proximity switch coupled to the second portion of the shaft assembly, the first proximity switch providing indexing feedback for the rotating drive to locate the lens held by each lens holder adjacent to the opening of each station, in turn, and for the reciprocating drive to subsequently move the first portion of the shaft assembly away from the second portion of the shaft assembly to transfer the lens held by each lens holder into each station, in turn, starting from the first lens loading position; and
a second proximity switch coupled to the first portion of the shaft assembly, the second proximity switch providing homing feedback for the rotating drive to transfer the lens holder of each of the first and second arms back to the first lens loading position, following transfer to the unloading position.

21. The system of claim 9, wherein the lens holder of the first arm is spaced apart by approximately 120 degrees from the lens holder of the second arm.

22. A lens handling assembly for a lens coating system, the assembly comprising:
a shaft assembly including a first portion and a second portion, the first portion reversibly engagable with the second portion;
at least one arm coupled to the first portion of the shaft assembly and extending outward therefrom;
a lens holder coupled to each arm of the at least one arm;
a rotating drive coupled to the second portion of the shaft assembly for rotating the at least one arm about an axis of the shaft assembly, when the first portion of the shaft assembly is engaged with the second portion of the shaft assembly, such that the lens holder travels along a pathway surrounding the shaft assembly; and
a reciprocating drive coupled to the first portion of the shaft assembly, the reciprocating drive for moving the first portion of the shaft assembly away from the second portion of the shaft assembly, thereby disengaging the first portion from the second portion to transfer a lens held by each lens holder into a lens processing station of the lens coating system, and for subsequently moving the first portion back toward the second portion and into engagement with the second portion.

23. The assembly of claim 22, wherein the first portion of the shaft assembly is located below the second portion of the shaft assembly.

24. The assembly of claim 22, wherein the shaft assembly extends vertically.

25. The assembly of claim 22, wherein the pathway defines a circle approximately centered on the axis of the shaft assembly.

26. The assembly of claim 22,wherein:
the at least one arm comprises a first arm and a second arm; and
the lens holder of the first arm is spaced apart by approximately 120 degrees from the lens holder of the second arm, about the axis of the shaft assembly.

27. The assembly of claim 22, the lens holder of each arm comprises a suction cup and the assembly further comprises a vacuum sensor for each lens holder.
